(19) United States
(12) Patent Application Publication
(10) Pub. No.: US 2024/0281598 A1
(43) Pub. Date: Aug. 22, 2024

(54) System and Method for Table-to-Text Conversion and Paraphrasing

(71) Applicant: Israel Terungwa Agaku, Flint, MI (US)

(72) Inventor: Israel Terungwa Agaku, Flint, MI (US)

(21) Appl. No.: 18/110,918

(22) Filed: Feb. 17, 2023

(51) Int. Cl. G06F 40/177; G06F 40/30; G06Q 10/0631

(52) U.S. Cl. CPC G06F 40/177; G06F 40/30; G06Q 10/0631

(57) ABSTRACT

Systems and methods are disclosed herein for a computer-aided method for developing, customizing, and facilitating the process of developing text from tables. The mobile application or computer software is a 3 steps approach that is easy to use and provides efficient and effective output involving less time and input from the user.

### BACKGROUND

### Field of the Invention

This application relates generally to systems, methods and apparatuses, including computer programs, for machine processing of documents. More specifically, this application relates to extracting tabular data from documents using one or more computer processing techniques.

### Copyright Notice

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever

### DESCRIPTION OF THE RELATED ART

In a time when documents can exist in many forms and formats, the need for automatic document conversion software that can convert between these different formats has increased dramatically. One type of information in documents that is difficult to detect and convert accurately are tables. As explained herein below, the prior art approaches to convert tables offer only tolerable solutions that have much to be desired.

This is unfortunate since tables are useful in conveying much information in a compact format. One reason for the effective nature of conveying information through tables is that part of the information is presented by the structure of the table and is in fact inherent in the table structure. For example, column headings, row headings, table title, and the grouping of the information all can convey important information.

Since tables by their very nature convey information by their structure, it is important that any document conversion software accurately reflect the original structure in the converted form. As will be described herein below, some conversion software cannot handle the table structure and presents the table data as regular text, thereby stripping the structure that existed in the original table. As can be appreciated, much information is lost in such an approach. Other software attempts to convert the table and retain the structure, but do so poorly. For example, if a conversion software handles tables poorly, information can be presented inaccurately. For example, if a converted table has values that actually belong in a first column (i.e., the values are in the first column in the original document) mistakenly transported to another column, then the converted table provides incorrect data. In the best case, the information is obviously wrong and can be easily detected as such, and ignored by one who reads the document. However, in amore detrimental case, if the error is not obvious, then the one reading such a document can rely on the erroneous information to his or her peril. From the above, it can be seen that the accurate detection and conversion of tables from a document in a first format to a document in a second format are important tasks that, unfortunately, pose challenging problems to existing conversion software. There are currently several unsatisfactory approaches to this problem.

U.S. Pat. No. 5,841,900, entitled “Method for Graph-Based Table Recognition,” describes a bottom-up approach for recognizing tables in documents. In this approach, the document is first transformed into a layout graph with nodes and edges that represent document entities and their interrelations, respectively. Next, the layout graph is re-written using a set of rules based on apriori document knowledge and general formatting conventions. The graph is then utilized to locate tables in documents.

This bottom-up approach has several disadvantages. First, although the ′900 patent provides a more efficient way of transforming documents into corresponding layout graphs, this approach is nevertheless more computationally intensive than an approach that does not need a layout graph. In addition, segmenting every document into a corresponding layout graph with its objects is a generally complex programming process and is not easily implemented. Second, the step of re-writing the graph requires access to a set of rules and formatting conventions that consume additional memory.

Some document conversion programs attempt to perform automatic document conversion from one format to another. For example, there are commercial products that attempt to convert text in Adobe Portable Document Format (PDF) to Hypertext Markup Language (HTML) Unfortunately, these products handle tables very poorly. In fact, these products “flatten the table” (i.e., these products represent tables as straight text with no structure whatsoever). For example, a table having four rows and four columns would be converted to four lines of straight text. As discussed previously, it is undesirable to remove the table structure since removing the structure causes important information conveyed by the table structure or inherent therein to be lost.

Other document conversion software programs require a user to manually identify where the tables are in a document so that the tables can be converted to a structured form. For example, document conversion software programs, such as Gemini from Iceni Technology Limited of Norwich, England or Redwing from Datawatch, Inc. of Lowell, Mass. both require manual intervention in order to perform table conversion. Manual intervention is undesirable for at least two reasons. First, manual intervention consumes a user's time and effort. Second, manual intervention prevents the ability to process document: conversion off-line, such as by utilizing batch processing. Batch processing is particularly important in instances where there are numerous documents to convert from one form to another.

Furthermore, there are several challenges that may arise when using artificial intelligence (AI) solutions for high-precision tables (e.g., those in scientific publications) and inferences, including Data Quality, Model accuracy, Model Complexity, Explain ability and other factors.

In order for an AI model to accurately synthesize or interpret the data in a high-precision table, it is important that the data is of high quality. This includes having accurate and complete values, as well as properly formatted and structured. If the data is noisy, incomplete, or poorly formatted, the AI model may produce incorrect or unreliable results.

Furthermore, in order to synthesize or interpret the data in a high-precision table accurately, the AI model must be highly accurate. This may require training the model on a large, high-quality dataset and fine-tuning the model's hyperparameters to achieve the best possible performance.

The Model complexity in some cases, synthesizing or interpreting the data in a high precision table may require a complex AI model with many layers and a large number of parameters. This can make the model more difficult to train and may require more computational resources.

Also, in some cases, it may be important to understand how an AI model arrived at a particular synthesis or interpretation of the data. However, some AI models, particularly deep learning models, may be difficult to explain or interpret, making it challenging to understand the basis for their conclusions. The AI models can be influenced by biases present in the data they are trained on, which can lead to biased or unfair results. When synthesizing or interpreting the data in a high-precision table, it is important to consider the potential for bias and take steps to mitigate it.

Some non-AI data extraction tools are available for automating the process of extracting data from tables and converting it to text format. These alternatives may potentially be suitable for cases where the use of AI is not desired or not: feasible. However the accuracy and reliability of these tools may vary, and they are not designed for scientific tables. For example, optical character recognition (OCR) software could be used to extract the data from the table. OCR software works by analyzing an image of the table and converting the text contained within it into a digital format that can be edited or processed. OCR software is commonly used to convert scanned documents or images into editable text, and may be able to handle tables with reasonable accuracy. However, the simplistic, verbatim output produced by non-AI options for table to text conversion can be a problem in cases where some inference or synthesis is required, such as with statistical tables. This is because the resulting text will not contain any additional information or context beyond what is present in the original table, and may not be easily understood by someone who is not familiar with the content of the table. in general, the non-AI options for table to text conversion tend to produce a straightforward, verbatim representation of the original table without any synthesis or additional processing. The resulting text will typically have the same structure as the original table, with each row represented on a new line and the columns separated by a fixed number of spaces or other delimiter.

For example, consider the statistical table as shown in FIG. 1. If this table were converted to text using a basic “table to text” non-AI tool, the resulting text would simply repeat the information from the original table, like this:

### Age Group Male Female

| Age group | Male | Female |
|---|---|---|
| 18-24 | 10 | 20 |
| 25-34 | 15 | 25 |
| 35-44 | 20 | 30 |
| 45-54 | 25 | 35 |
| 55-64 | 30 | 40 |

While this text may be accurate, it does not provide any additional context or interpretation of the data, and may not be easily understood by someone who is not familiar with the meaning of the table. In order to fully understand the table, the reader would need to know what the age groups represent, what the numbers in the table represent, and how to interpret the data or fully understand the implications of the results presented in the table. One challenge with converting a statistical table that includes p values to text is that the p values may not be considered in the resulting text. This can be problematic because p values are used to assess the statistical significance of the results presented in the table, and are an important part of understanding and interpreting the data. For example, a reader may not be able to determine whether a particular result is statistically significant or whether it may have occurred by chance. This can make it difficult to draw meaningful conclusions from the data and can limit the usefulness of the text for further analysis or decision-making.

To address this issue, the current method discusses a custom, rule-based solution that can perform some level of synthesis or interpretation of the data presented in epidemiologic research. This could involve adding additional context or information to the text, such as descriptions of the subpopulations or explanations of the statistical concepts being illustrated in the table. The features described below, including the ability to convert tables to text and synchronize the resulting text with the main text of the paper, are being demonstrated using an online platform for automated data analysis called Chisquares. The Chisquares ecosystem has five advanced platforms within it, one of which is CollaboWrite. However, these features can be applied to other systems as well, allowing for the seamless integration of data tables and synthesized results into a wide range of research projects.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

It is therefore the purpose of the invention to alleviate at least to some extent one or more of the aforementioned problems of the prior art and/or to provide the relevant public with a suitable alternative thereto having relative advantages.

The primary object of the invention is related to the provision of an improved computer program that aims on facilitating the process of a custom, rule-based solution that can perform some level of synthesis or interpretation of the data presented in epidemiologic research

It is further the objective of the invention to provide a method, apparatus, and computer instructions for providing a platform that involves adding additional context or information to the text, such as descriptions of the subpopulations or explanations of the statistical concepts being illustrated in the table.

It is also the objective of the system to provide a method whereby it provides the ability to convert tables to text and synchronize the resulting text with the main text of the paper, is being demonstrated using an online platform for automated data analysis called Chisquares.

It is also the objective of the invention to provide a platform which is in form of a mobile application, computer software, and a website specialized for organizing tables to text format.

It is further the objective of the invention to provide a level of Chisquares ecosystem that has five advanced platforms within it, one of which is CollaboWrite. However, these features can be applied to other systems as well, allowing for the seamless integration of data tables and synthesized results into a wide range of research projects.

It is moreover the objective of the invention to provide an application which is compatible for all types of Android and iOS systems.

It is further the objective of the invention to provide a system that is easy to use, easy to implement and provides an advanced methodology of facilitation of debates and discussions.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 depicts the table in accordance with the embodiments of the invention.

FIG. 2 depicts the profile page in accordance with the embodiments of the invention.

FIG. 3 depicts the overview page in accordance with the embodiments of the invention.

FIG. 4 depicts the datasheet upload page in accordance with the embodiments of the invention.

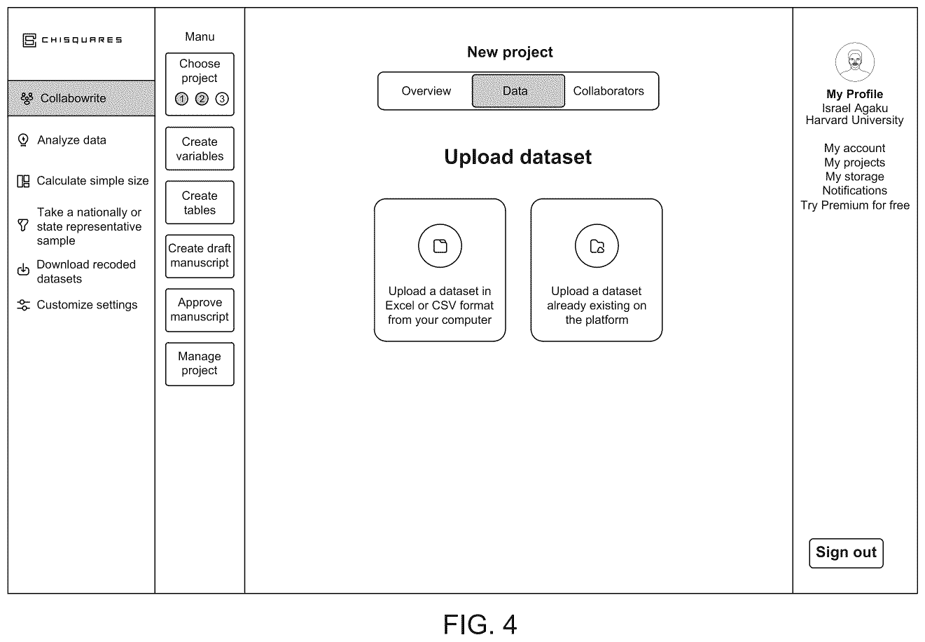

The apparatus and method components have been represented where appropriate by conventional symbols in the drawings, showing only those specific details.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

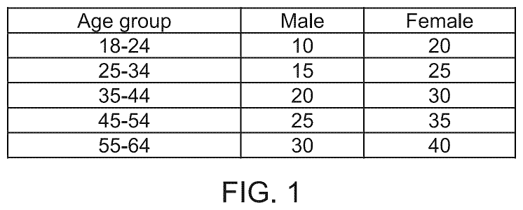

The proposed system aims to provide a platform designed specifically for collaborative, automated scientific writing as shown in FIG. 1. It allows researchers to efficiently and effectively develop manuscripts by ingesting raw data and applying advanced analysis tools to extract meaningful insights and generate high-quality results. To facilitate this process, CollaboWrite includes a range of features and tools that enable users to analyze data, create tables, and synthesize results in real-time. These features are essential for effectively communicating the findings of the research to a wide audience and enabling others to understand and interpret the data. One of the key features of CollaboWrite is the ability to convert tables to text, allowing users to easily and accurately present their data and findings in a clear and concise manner. By automating this process, CollaboWrite saves time and effort for researchers and ensures that the results are presented in a consistent and professional manner.

The system involves an easy-to-use method and interface. To start work on a new research project, the user must execute (or skip) three sets of tasks: they must provide the project overview (which is shared with co-authors when they are being invited, as well as parsed out to help developed several aspects of the paper automatically); (2) upload the dataset that will be analyzed for the study; (3) invite collaborators.

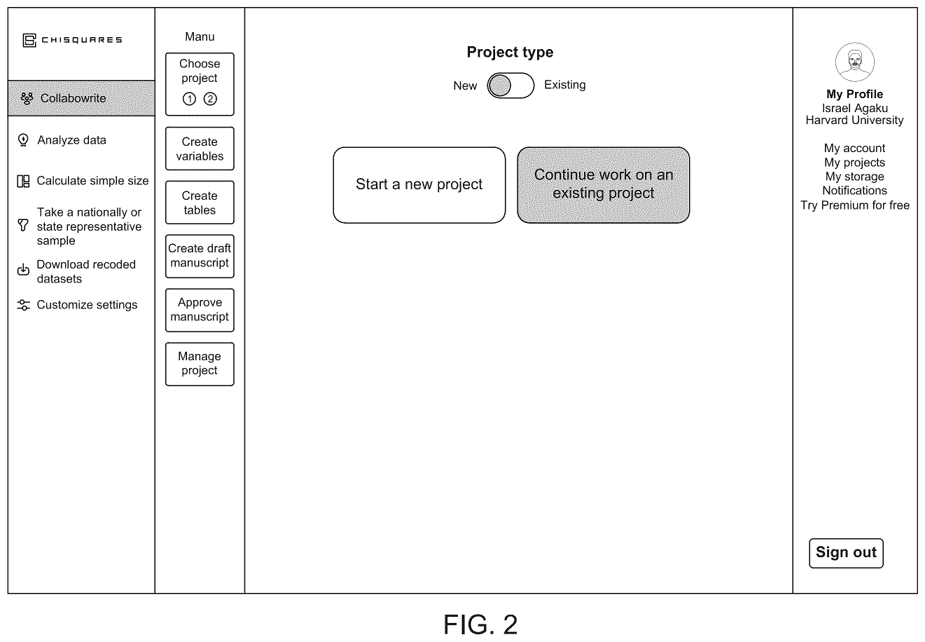

The project initiator completes a form as shown in FIG. 2, that provides basic information about the project, including why, where, how, and when it was conducted. Hints are provided throughout the form to guide the user. Also, leading segments of text are provided so the user can easily complete the appropriate section.

Users can upload the dataset to be analyzed from one of three places: (1) their personal computer or an external hard drive (2) Their personal storage space within the Chisquares environment; (3) Any one of the cleaned publicly available datasets in the common Chisquares storage accessible to all users. Only the project initiator or those designated as leads or co-leads can upload or change an uploaded dataset for a project. Users can also skip this step if the study does not involve analysis of a dataset.

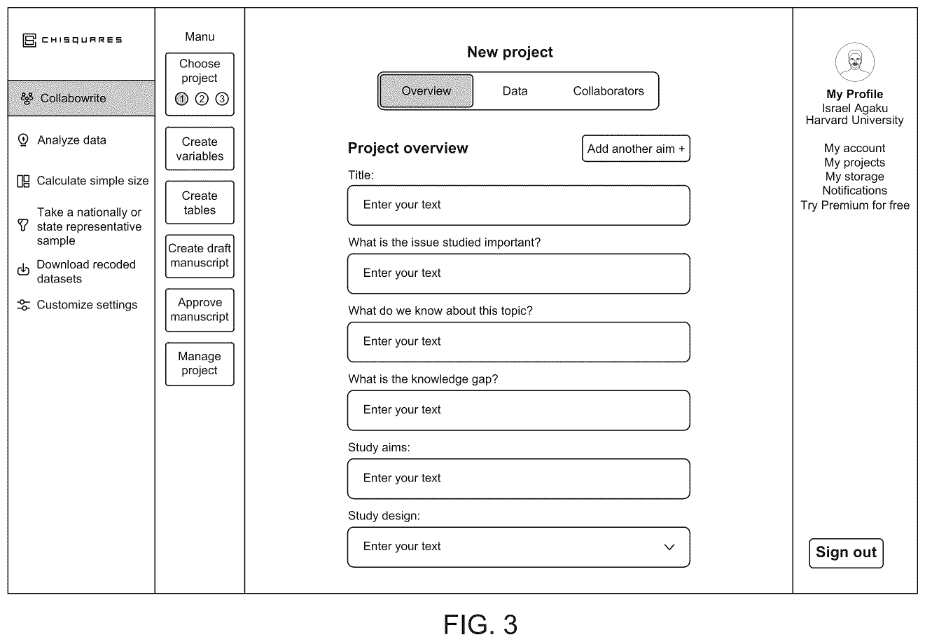

After importing the dataset, the user is asked whether the analysis will require weighting of the data as shown in FIG. 3. In general, when analyzing complex survey data, there are up to three variables that need to be accounted for in the analysis to ensure the results are not biased. These are the weight variable, primary sampling unit (PSU) variable, and the strata variable. The weight variable adjusts for the mean or prevalence, while the PSU and strata variables adjust for the variance (e.g., confidence intervals). The PSU and strata variables may or may not be present, but the weight variable is always present in every complex survey data. In every other software for analysis of complex survey data, the user must specify these variables every single time they are using the data. On the Chisquares platform, this will need to be done only once at the point of importing the data into the platform. The platform remembers this selection throughout the lifecycle of the dataset on the Chisquares platform. Should the selection have been made in error, the lead/co-lead can also make changes to the weighting variable within the main workstation. If the dataset being analyzed is not from a complex survey (i.e. no weighting required), the step to specify the required weighting variables is skipped automatically as shown in the screenshots below.

The next step is to invite collaborators. This step can be skipped if there are no collaborators (i.e., solo project). If there are collaborators, the project initiator provides their information including name, highest academic degrees, institution, country, and email. These pieces of information will be used to auto populate the list of authors in the main manuscript text (most journals require this exact same information for all authors). For each invited individual, the project initiator can choose the “Assigned task” (e.g., “Assist with analysis”); they can also choose to assign one or more individuals as a “Co-lead”.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

A function will be designed to facilitate the creation of tables from raw data imported into the platform. To achieve this, the function will accept a set of parameters as input, including the name of the dataset, the variables to be included in the table, and optional inclusion criteria, weighting, stratification, and sampling unit variables. To ensure the statistical validity of the resulting table, the function will implement complex survey design methods, if applicable, to account for the sampling method used in the data collection process. This will ensure that the tabulation accurately reflects the characteristics of the population being studied. Once the table has been generated, it will be stored in the form of a dataframe, a common data structure that organizes data into rows and columns which provides a convenient and efficient way to create text from the analyzed tables and to extract and synthesize relevant information with minimal effort.

The synchronization and dynamism between the generated tables and associated content is achieved through a series of processes. When a table is deleted in the “View tables” mode, all corresponding text and figures associated with that table in the main text, including in the methods, results, and tables/figures sections, will also be deleted. The order in which the tables appear in the “View tables” window determines the signposting of text derived from the tables in the results section and the arrangement of tables and figures at the end of the manuscript. Additionally, the methodology behind the various tables is organized based on the order of the tables in the “View tables” window. Modifying the order of the tables in the “View tables” window will automatically rearrange the order of all material derived from the tables, including within the methods and results sections, as well as the arrangement of tables and figures at the end of the main text. This system allows for seamless coordination and synchronization between the generated tables and corresponding content.

The methodology for the study will be automatically organized and presented in the methods section of the manuscript. When multiple tables are generated, they will be presented in a logical and clear order for the reader to follow. For example, the order may be as follows: (1) Characteristics of the study population, which includes demographic information about the participants; (2) Table 2. Overall prevalence estimates, which presents the overall estimates for the outcomes being studied; (3) Table 3. Stratified prevalence estimates, which presents estimates for subgroups within the study population; (4) Table 4. Regression tables, which present the results of the statistical analysis. If there are multiple tables of stratified prevalence estimates, they will be presented in chronological order in all applicable places.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

We claim:

1: A system and method of table-to-text conversion and paraphrasing comprising:
User providing the project overview (which is shared with co-authors when they are being invited, as well as parsed out to help developed several aspects of the paper automatically);
User uploading the dataset that will be analyzed for the study; and, invite collaborators.
The system as per claim 1, involves the project initiator completing a form that provides basic information about the project, including why, where, how, and when.
The system as per claim 1, involves the project initiator completing a form and hints are provided throughout the form to guide the user.
The system as per claim 1, involves the project initiator completing a form and leading segments of text are provided so the user can easily complete the appropriate section.
The system as per claim 1, involves the project initiator uploading the dataset to be analyzed from one of three places: (1) their personal computer or an external hard drive (2) Their personal storage space within the Chisquares environment; (3) Any one of the cleaned publicly available datasets in the common Chisquares storage accessible to all users.
The system as per claim 1, involves the project initiator or those designated as leads or co-leads can upload or change an uploaded dataset for a project. Users can also skip this step if the study does not involve analysis of a dataset.
The system as per claim 1, involves importing the dataset, and the user is asked whether the analysis will require weighting of the data.
The system as per claim 1, involves analyzing complex survey data, there are up to three variables that need to be accounted for in the analysis to ensure the results are not biased.
The system as per claim 1, involves the weight variable, the primary sampling unit (PSU) variable, and the strata variable.
The system as per claim 1, wherein the weight variable adjusts for the mean or prevalence, while the PSU and strata variables adjust for the variance (e.g., confidence intervals).
The system as per claim 1, wherein the PSU and strata variables may or may not be present, but the weight variable is always present in every complex survey data.
The system as per claim 1, wherein the user must specify variables single time they are using the data and the platform remembers this selection throughout the lifecycle of the dataset on the Chisquares platform.
The system as per claim 1, wherein the dataset being analyzed is not from a complex survey (i.e., no weighting required), the step to specify the required weighting variables is skipped automatically as shown in the screenshots below.
The system as per claim 1, wherein the next step involves inviting collaborators.
The system as per claim 1, involves the collaborators, the project initiator provides their information including name, highest academic degrees, institution, country, and email.
The system as per claim 1, involves the information will be used to auto-populate the list of authors in the main manuscript text (most journals require this exact same information for all authors).
The system as per claim 1, involves for each invited individual, the project initiator can choose the “Assigned task” (e.g., “Assist with analysis”); they can also choose to assign one or more individuals as a “Co-lead”.

2: A function designed to facilitate the creation of tables from raw data imported into the platform comprising:
A system and method to generate text from the table as per claim 2, wherein the function will accept a set of parameters as input, including the name of the dataset, the variables to be included in the table, and optional inclusion criteria, weighting, stratification, and sampling unit variables.
A system and method to generate text from the table as per claim 2, wherein to ensure the statistical validity of the resulting table, the function will implement complex survey design methods, if applicable, to account for the sampling method used in the data collection process.
A system and method to generate text from the table as per claim 2, wherein the system will ensure that the tabulation accurately reflects the characteristics of the population being studied.
A system and method to generate text from the table as per claim 2, wherein once the table has been generated, it will be stored in the form of a dataframe, a common data structure that organizes data into rows and columns which provides a convenient and efficient way to create text from the analyzed tables and to extract and synthesize relevant information with minimal effort.
